(19) United States
(12) Patent Application Publication
(10) Pub. No.: US 2004/0250463 A1
(43) Pub. Date: Dec. 16, 2004

(54) Knotless tapered leader dispensing system

(76) Inventor: Ted M. Haines, Temple Terrace, FL (US)

Correspondence Address: Law Offices of Adam H. Jacobs, Suite 726, 1904 Farnam Street, Omaha, NE, 68102, US

(21) Appl. No.: 10/857,518

(22) Filed: May 28, 2004

Related U.S. Application Data
(60) Provisional application No. 60/474,071, filed on May 29, 2003.

(51) Int. Cl. A01K 91/00

(52) U.S. Cl. 43/54.1

(57) ABSTRACT

A knotless tapered leader dispensing system includes at least two tapered leaders connected to one another at one end thereof to form a generally continuous leader string. Each of the tapered leaders are generally longitudinally extended and flexible and each further include a butt end having a first diameter and a tippet end having a second diameter less than the first diameter, with the leaders tapering from the butt end to the tippet end. A spool dispenser having a central reel is used with the generally continuous leader string being wrapped around the central reel of the spool dispenser such that dispensing of one of the tapered leaders includes unreeling the tapered leader from the central reel of the spool dispenser and separating and removing the tapered leader from the generally continuous leader string at a marked leader connection section interposed therebetween.

### CROSS-REFERENCE TO RELATED PROVISIONAL PATENT

This application claims priority based on a provisional patent, specifically on the Provisional Patent Application Ser. No. 60/474,071 filed May 29, 2003.

### BACKGROUND OF THE INVENTION

1. Technical Field

The present invention is directed to fly fishing accessories and, more particularly, to a knotless tapered leader dispensing system which includes at least two tapered leaders connected to one another at one end thereof to form a generally continuous leader string, the leader string being wrapped around a spooled dispenser such that dispensing of a tapered leader involves unreeling the tapered leader from the spool and cutting the tapered leader from the remaining leader string thereby quickly and easily supplying a tapered leader for use in a fly fishing situation.

2. Description of the Prior Art

Some background information may be helpful to determine the necessity for the present invention. Tapered leaders are used primarily in fly fishing. Traditional tapered leaders were tied by hand from many different types of leader material. An angler tying a five-section tapered leader would need five spools of line each having different diameters and the angler would tie together the different sections of line to form the tapered leader which includes connecting knots. Needless to say, the amount of effort required to produce such a leader is substantial and, furthermore, the knots tied by the angler each represent a potential breaking point for the line, which is also undesirable. For this reason, manufacturing of knotless tapered leaders was begun to provide the angler with a relatively simple-to-use alternative. These manufactured knotless tapered leaders are produced in various sizes, shapes and with various construction materials and are generally manufactured by stretching, shaping or carving of the line, or most often by extrusion, or by a combination of the above-described methods. The result is that the completed knotless tapered leader includes a tippet end having a small diameter for attachment to the fly and a butt end which is thicker to attach to the fly line itself.

One problem that the knotless tapered leaders have is that they are packaged as single coiled units which, when removed from the package, are difficult to uncoil and often become tangled and thus can be easily damaged, as shown best in FIG. 3. Also, this takes an inordinate amount of time to complete the uncoiling and attaching of the leader to the line, which takes away from valuable fishing time. At the present time, there is no known dispensing system which can easily and quickly dispense a single tapered leader for use by an angler, and it is this need that the present invention is intended to solve, in addition to providing high-quality tapered leaders for anglers.

Therefore, an object of the present invention is to provide an improved knotless tapered leader dispensing system.

Another object of the present invention is to provide an improved knotless tapered leader dispensing system in which the two or more tapered leaders are secured to one another in end-to-end connection to form a generally continuous leader string having a colored leader connection section interposed therebetween to signify the end of one tapered leader and the start of the next.

Another object of the present invention is to provide an improved knotless tapered leader dispensing system in which the generally continuous leader string is wrapped around a spooled dispenser having a central winding spool structure to ease the dispensing of the leaders from the leader string.

Another object of the present invention is to provide an improved knotless tapered leader dispensing system in which the spooled dispenser is enclosed in a generally cylindrical canister having a dispensing hole formed therein to protect the tapered leaders wound on the spooled dispenser and generally prevent unintentional unwinding of the tapered leaders off of the spooled dispenser.

Finally, an object of the present invention is to provide an improved knotless tapered leader dispensing system which is relatively simple in construction and is safe and efficient in use.

### SUMMARY OF THE INVENTION

The present invention provides a knotless tapered leader dispensing system including at least two tapered leaders connected to one another at one end thereof to form a generally continuous leader string. Each of the at least two tapered leaders are generally longitudinally extended and flexible and each further include a butt end having a first diameter and a tippet end having a second diameter less than the first diameter, the diameter of each of the at least two tapered leaders between the butt end and the tippet end being at least generally equal to the second diameter and at most generally equal to the second diameter. A spool dispenser having a central reel is used with the generally continuous leader string being wrapped around the central reel of the spool dispenser such that dispensing of one of the at least two tapered leaders includes unreeling the one tapered leader from the central reel of the spool dispenser and separating and removing the one tapered leader from the generally continuous leader string at a marked leader connection section interposed between the one tapered leader and the generally continuous leader string thereby quickly and easily supplying a tapered leader for use in a fishing situation.

The present invention is specifically designed to assist the fly fisherman in quickly and easily obtaining and using a tapered leader without all of the standard problems which remain unsolved by the prior art. For example, because the tapered leaders are held on a spool and include the marked leader connection sections interposed between the tapered leaders, the user of the present invention may unreel one leader and separate it from the remaining leader string without having to have multiple leader packages available at all times. Furthermore, because the leaders are housed within a container that does not need to be opened to access the leaders, the leaders are protected from external elements, which permits the leaders to retain their structural integrity. Finally, because the present invention can be used to quickly dispense a tapered leader, valuable fishing time will not be lost during the search for a replacement tapered leader. The present invention thus provides a substantial improvement over those devices and dispensing systems found in the prior art.

### BRIEF DESCRIPTION OF THE DRAWINGS

FIG. 1 is a perspective view of the leader string and dispenser of the present invention;

FIG. 2 is a perspective view of the spool dispenser of the present invention showing the leader string wrapped thereon;

FIG. 3 is a perspective view of the prior art;

FIG. 4 is a perspective view of an alternative embodiment of the invention in which the spool itself serves as the dispensing device;

FIG. 5 is a side elevational view of the spool dispenser and leader string showing the leader connection sections; and

FIG. 6 is a perspective view of a fisherman using the tapered leader of the present invention.

### DESCRIPTION OF THE PREFERRED EMBODIMENT

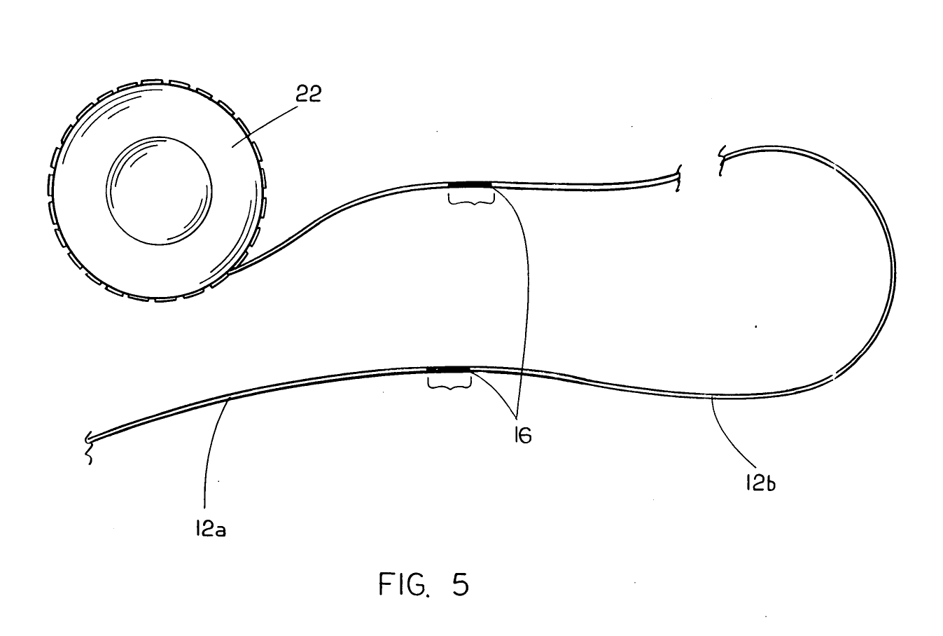

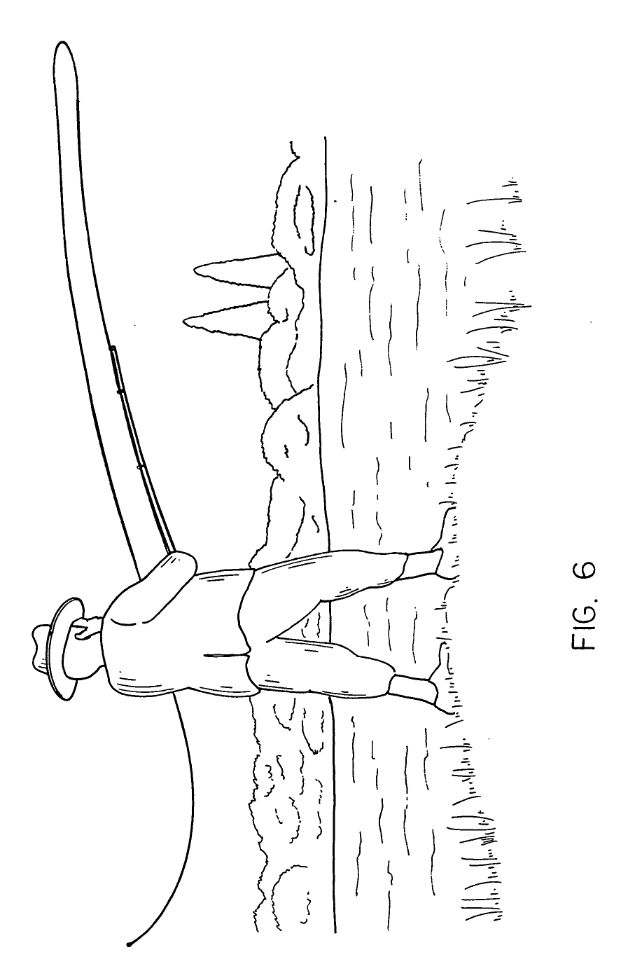

The knotless tapered leader dispensing system 10 of the present invention is shown best in FIGS. 1, 2, 4 and 5 as including at least two tapered leaders 12a and 12b which are connected to one another as part of the manufacturing process for producing the tapered leaders. It should be noted that many more than just two leaders may be used with the present invention, with the exact number of leaders being used being determined by the production and marketing restrictions and requirements which are only peripherally a part of this invention. Taken together, the tapered leaders 12a and 12b form a leader string 14.

In the present invention, construction of the leader string 14 would be performed by creating a connected succession of tapered leaders 12a and 12b which are connected to one another during the construction process of the leader string 14 by a discardable leader connection section 16 which extends between and connects the tapered leaders 12a and 12b, thus securing the tapered leaders 12a and 12b in one of a butt-to-butt, tippet-to-tippet, or tippet-to-butt configuration in leader string 14. In the preferred embodiment, this leader connection section 16 would be dyed to make it stand out from the remainder of the leader string 14 and would have a length of approximately two inches up to twenty-four inches (2″to 24″) so that the angler dispensing tapered leaders 12a and 12b from the leader string 14 will know when the end of the tapered leader 12a being dispensed has been reached.

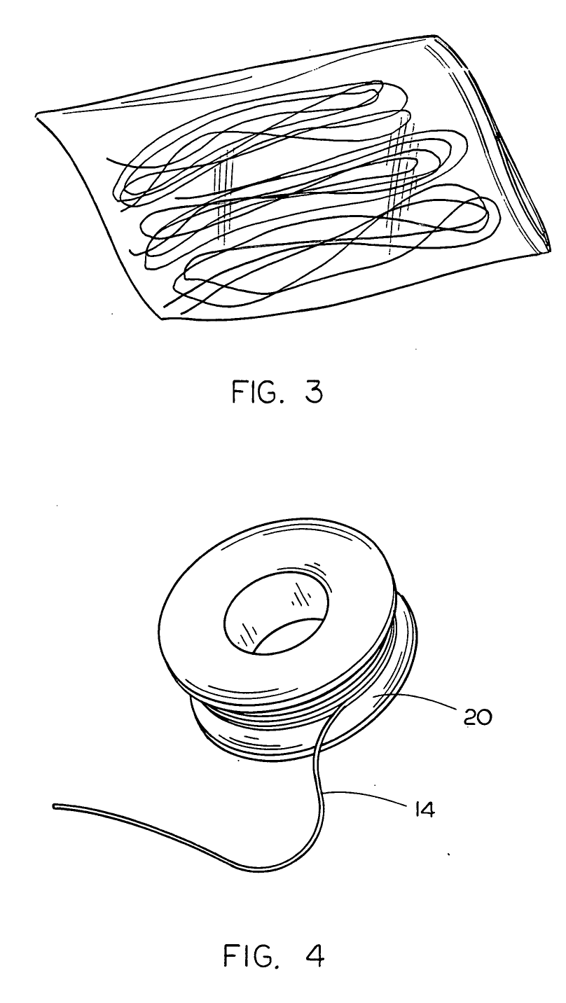

In the preferred embodiment, the leader string 14 would be wound onto a spool 20, with the number of leaders in the leader string 14 being determined on a case-by-case basis depending on the marketing and production requirements of the manufacturer and/or distributor. The spool 20 would preferably have a diameter of approximately 1″ to 3″ and the leader string 14 would be wound around the center reel 21 of the spool 20 as shown best in FIG. 3. Once the leader string 14 is wound onto spool 20, the spool 20 would then be fitted within a dispensing canister 22 which would preferably include a spool-retaining body 24, lid 26, and a leader string dispensing hole 28 formed in the side wall of spool-retaining body 24. The dispensing canister 22 would be assembled by placing the spool 20 holding the leader string 14 within the spool-retaining body 24 of dispensing canister 22 and extending the free end of tapered leader 12a through leader string dispensing hole 28 prior to releasably securing lid 26 onto spool-retaining body 24, thus securing spool 20 within dispensing canister 22.

Alternatively, the spool 20 could be used by itself to hold and dispense the leader string 14 as shown best in FIG. 4. In fact, due to the common packaging and display units used for fishing line and leaders, it may be preferably to use the spool 20 by itself for holding and dispensing the leader string 14 as the spool 20 would be supported on a display hook or post extending through the center hole of the spool 20, the display hook or post being mounted in the retail store location in which the spool of leaders is being offered for sale.

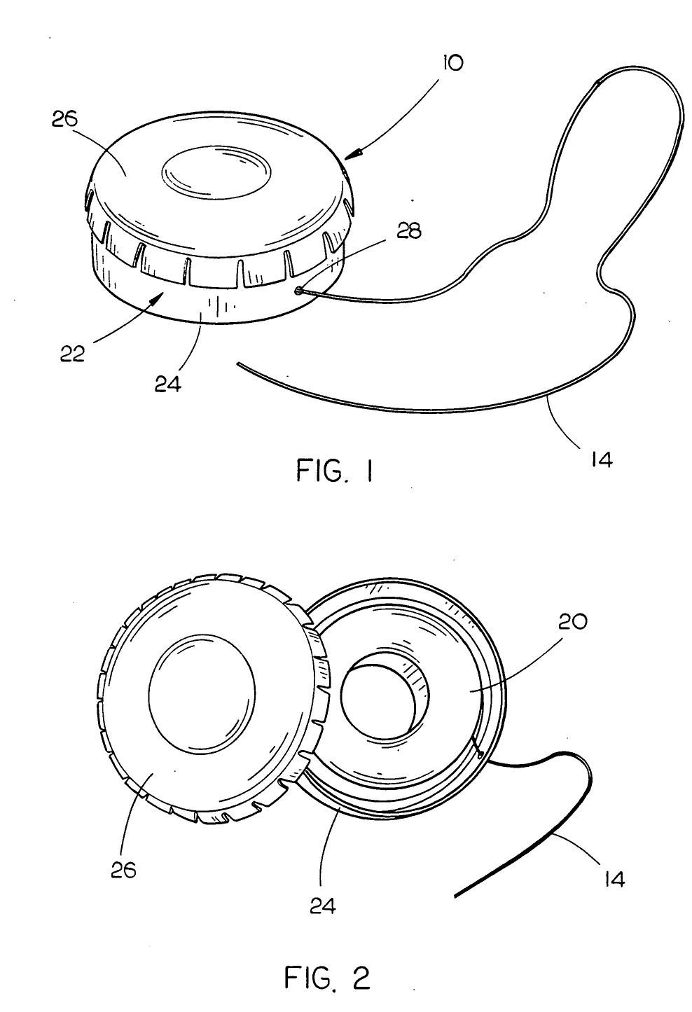

Returning to the embodiment of FIGS. 1 and 2, as the tapered leader 12a is removed through leader string dispensing hole 28, the leader string 14 on spool 20 is unwound, thus releasing tapered leader 12a through the leader string dispensing hole 28. In the preferred embodiment, each tapered leader 12a and 12b would be approximately eight to ten feet in length, and once the end of tapered leader 12a is reached, the angler is made aware of the end of tapered leader 12a by viewing the marked leader connection section 16 which exits through leader string dispensing hole 28 from spool 20, the leader connection section 16 being signified by the dye or other such marking on the leader connection section 16. The angler would then separate tapered leader 12a from tapered leader 12b at leader connection section 16 by a knife or other similarly sharp instrument, discarding the leader connection section 16, and the tapered leader 12a is thus ready for use in a fly fishing situation. The tapered leader 12b and remainder of leader string 14 remains wound on spool 20 within dispensing canister 22 awaiting the next use of the knotless tapered leader dispensing system 10 of the present invention.

In the case of the use of only the spool 20 for dispensing of the leader string 14, the leader string 14 on spool 20 is unwound as described above minus the extension of the leader string 20 through the canister wall. The leader string 14 would be cut and used as was previously described, although it may be desirable to include a rubber band or other such elastic band which would be slipped over the spool 20 onto the leader string 14 to keep the leader string 14 wound on the spool 20 until such time as another leader is to be removed from the leader string 14.

The present invention thus provides a substantial improvement over those devices found in the prior art. For example, as shown best in FIG. 3, the monofilament leaders of the prior art are merely dropped into a plastic bag or the like prior to marketing thereof, which renders the leaders very difficult to remove from the plastic bag without tangling the leaders into one another. Since the purpose of fly fishing is to provide enjoyment for the angler, spending any length of time removing tangles and knots from a plurality of leaders in order to be able to attach a new leader to a fly line severely reduces the opportunity for enjoyment and thus is undesirable. The use of the present invention permits the quick and simple dispensing of tapered leaders 12a and 12b from the dispensing canister 22 which can be easily carried by the angler either in his or her pocket or in a tackle box without risking entanglement of leaders with other items being stored in the tackle box. Also, because there is no restriction on the ultimate size of the spool 20 and length of leader string 14, a large number of tapered leaders 12a and 12b may be connected to one another to form the leader string 14 prior to being wound onto the spool 20 in order to supply a greater number of leaders to the angler in an easily dispensable form. Furthermore, it is expected that a manufacturing of continuous tapered leaders and the winding of the leader string 14 onto the spool 20 for dispensing from the dispensing canister 22 will greatly reduce the overall cost of the tapered leaders 12a and 12b, thus resulting in a savings to the angler and an increase in enjoyment.

It is to be further noted that numerous additions, substitutions and modifications may be made to the present invention which fall within the intended broad scope of the appended claims. For example, the precise construction methods and materials used for the leader string 14 and tapered leaders 12a and 12b may be modified or changed so long as the tapered leaders 12a and 12b are connected to one another to form the leader string 14 and include a leader connection section 16 formed therebetween. Also, the spool 20 and dispensing canister 22 may be constructed of various materials such as plastic, metal, or other such construction materials and, further, may be of various sizes, shapes, and include different features than those described previously. Finally, it may be entirely possible to use the present invention without the dispensing canister 22 yet still retain the continuous leader string 14 which is dispensed from a spool dispensing container such as that shown in FIG. 4 to generally prevent tangling of the tapered leaders 12a and 12b, a modification which falls within the scope of this disclosure and the appended claims.

There has therefore been shown and described a knotless tapered leader dispensing system 10 which accomplishes at least all of its intended objectives.

I claim:

1. A knotless tapered leader dispensing system comprising:
at least two tapered leaders connected to one another at one end thereof to form a generally continuous leader string;
each of said at least two tapered leaders being generally longitudinally extended and flexible and each further including a butt end having a first diameter and a tippet end having a second diameter less than said first diameter, the diameter of each of said at least two tapered leaders between said butt end and said tippet end being at least generally equal to said second diameter and at most generally equal to said second diameter;
a spool dispenser having a central reel; and
said generally continuous leader string being wrapped around said central reel of said spool dispenser such that dispensing of one of said at least two tapered leaders includes unreeling said one tapered leader from said central reel of said spool dispenser and separating and removing said one tapered leader from said generally continuous leader string at a marked leader connection section interposed between said one tapered leader and said generally continuous leader string thereby quickly and easily supplying a tapered leader for use in a fishing situation.

2. The knotless tapered leader dispensing system of claim 1 wherein said spool dispenser further comprises releasable leader retention means for preventing unintentional unspooling of said generally continuous leader string.

3. The knotless tapered leader dispensing system of claim 1 further comprising a dispensing canister including a spool-retaining body, a lid, and a leader string dispensing hole formed in a wall of said spool-retaining body, said spool dispenser with said leader string thereon supported within said spool-retaining body of said dispensing canister with one end of said leader string extending through said leader string dispensing hole for dispensing of said leader string from said dispensing canister.

4. A knotless tapered leader dispensing system comprising:
at least three tapered leaders connected in linear alignment with adjacent ones of said at least three tapered leaders connected to one another at one end thereof to form a generally continuous leader string;
each of said at least three tapered leaders being generally longitudinally extended and flexible and each further including a butt end having a first diameter and a tippet end having a second diameter less than said first diameter, the diameter of each of said at least three tapered leaders between said butt end and said tippet end being at least generally equal to said second diameter and at most generally equal to said second diameter;
supporting and dispensing means operative to support said at least three tapered leaders thereon and restrictively dispense said at least three tapered leaders one at a time; and
said generally continuous leader string being wrapped around said supporting and dispensing means such that dispensing of one of said at least three tapered leaders includes unreeling said one tapered leader from supporting and dispensing means and separating and removing said one tapered leader from said generally continuous leader string at a marked leader connection section interposed between said one tapered leader and said generally continuous leader string thereby quickly and easily supplying a tapered leader for use in a fishing situation.

5. The knotless tapered leader dispensing system of claim 4 wherein said spool dispenser further comprises releasable leader retention means for preventing unintentional unspooling of said generally continuous leader string.

6. A knotless tapered leader dispensing system comprising:
at least two tapered leaders connected to one another at one end thereof to form a generally continuous leader string;
each of said at least two tapered leaders being generally longitudinally extended and flexible and each further including a butt end having a first diameter and a tippet end having a second diameter less than said first diameter, the diameter of each of said at least two tapered leaders between said butt end and said tippet end being at least generally equal to said second diameter and at most generally equal to said second diameter;
a spool dispenser having a central reel;
a dispensing canister including a spool-retaining body, a lid, and a leader string dispensing hole formed in a wall of said spool-retaining body;
said generally continuous leader string being wrapped around said central reel of said spool dispenser;
said spool dispenser with said leader string thereon supported within said spool-retaining body of said dispensing canister with one end of said leader string extending through said leader string dispensing hole for dispensing of said leader string from said dispensing canister such that dispensing of one of said at least two tapered leaders includes unreeling said one tapered leader from said central reel of said spool dispenser out of said leader string dispensing hole and separating and removing said one tapered leader from said generally continuous leader string at a marked leader connection section interposed between said one tapered leader and said generally continuous leader string thereby supplying a tapered leader for use in a fishing situation.
